(19) United States
(12) Patent Application Publication
(10) Pub. No.: US 2005/0222944 A1
(43) Pub. Date: Oct. 6, 2005

(54) System and method for managing the reimbursement of expenses using expense reports

(76) Inventors: Richard S. Dodson JR., Glen Allen, VA (US); Richard A. Essex, Richmond, VA (US); James F. Kennedy JR., Glen Allen, VA (US); George N. Marchenko, Richmond, VA (US)

Correspondence Address: BAKER BOTTS L.L.P., 2001 ROSS AVENUE, SUITE 600, DALLAS, TX, 75201-2980, US

(21) Appl. No.: 10/971,826

(22) Filed: Oct. 22, 2004

Related U.S. Application Data
(60) Provisional application No. 60/513,912, filed on Oct. 22, 2003.

(51) Int. Cl. G06F 17/60

(52) U.S. Cl. 705/39

(57) ABSTRACT

A method of managing expenses is provided. An expense report including details of one or more expenses incurred by an employee is electronically received. Electronic images of one or more receipts associated with at least one of the one or more expenses are received. A computer-readable identifier corresponding with the expense report is electronically received in association with the one or more receipts. The expense report is automatically identified based on the received computer-readable identifier and, in response to identifying the expense report based on the received computer-readable identifier, a link is automatically generated between the identified expense report and the electronic images of the one or more receipts. The link may be used to retrieve the electronic images of the one or more receipts.

### TECHNICAL FIELD OF THE INVENTION

This invention relates in general to expense reports and, more particularly, to a system and method for managing the reimbursement of expenses using expense reports.

### BACKGROUND OF THE INVENTION

Business entities often use expense reports to reimburse certain expenses incurred by their employees. For example, if an employee makes various transactions during a business trip, such as airfare, hotel and food purchases, the employee typically must keep track of such expenses and save the receipts for such transactions. At some later time, the employee may fill out an expense report, including details regarding each transaction included in the expense report, and attach the receipts for the included transactions. The employee may then submit the expense report and receipts to a manager or accounting department for review. If the expense report is approved, the accounting department may issue a reimbursement check to the employee for an amount equal to the reimbursable expenses.

### SUMMARY OF THE INVENTION

In accordance with the present invention, system and methods are provided for managing the reimbursement of expenses using expense reports.

According to one embodiment, a method of managing expenses is provided. An expense report including details of one or more expenses incurred by an employee is electronically received. Electronic images of one or more receipts associated with at least one of the one or more expenses are received. A computer-readable identifier corresponding with the expense report is electronically received in association with the one or more receipts. The expense report is automatically identified based on the received computer-readable identifier and, in response to identifying the expense report based on the received computer-readable identifier, a link is automatically generated between the identified expense report and the electronic images of the one or more receipts. A request to retrieve one or more of the electronic images of the receipts may subsequently be received, and the generated link may be used to retrieve the requested one or more electronic images.

In some embodiments, details of a plurality of credit card transactions made using a credit card associated with the employee are received from a credit card processing system. A user interface may be provided that allows the employee or a delegate acting on behalf of the employee to select from the plurality of credit card transactions particular credit card transactions to be populated into the expense report. Using the user interface, the employee or a delegate may select of one or more credit card transactions associated with the expense report, and the details of such selected credit card transactions may be automatically populated into the expense report.

According to another embodiment, a system for managing expenses is provided. The system includes an expense report management module and an image management module. The expense report management module is operable to electronically receive an expense report including details of one or more expenses incurred by an employee. The image management module is operable to: receive electronic images of one or more receipts associated with at least one of the one or more expenses; electronically receive a computer-readable identifier associated with the one or more receipts, the computer-readable identifier corresponding with the expense report; automatically identify the expense report based on the received computer-readable identifier; and in response to identifying the expense report based on the received computer-readable identifier, automatically generate a link between the identified expense report and the electronic images of the one or more receipts, wherein the link may be used to retrieve the electronic images of the one or more receipts.

Various embodiments of the present invention may benefit from numerous advantages. It should be noted that one or more embodiments may benefit from some, none, or all of the advantages discussed below.

One advantage of the invention is that an improved system for managing the reimbursement of expenses using expense reports is provided. An employee that has made reimbursable transactions (e.g., business-related transactions) using a credit card may be provided easy access to automatically-collected details regarding such transactions such that the employee may select particular credit card transactions to be automatically populated into an expense report. Thus, the time and effort required for the employee to fill out an expense report may be reduced or minimized.

Another advantage of the invention is that the employee preparing an expense report may be provided a computer-readable identifier that represents an ID number assigned to the expense report (such as a bar code located on a cover sheet, for example). The computer-readable identifier may be faxed or otherwise electronically transmitted, along with receipts from transactions included in an expense report, to an image management system, which may identify the ID number of the expense report by automatically reading the computer-readable identifier, and index the received images of the receipts accordingly. Thus, a link may be generated between an expense report and the images of receipts associated with expenses listed on the expense report. Such link may be used for retrieving the receipt images, such as during a review of the expense report by a manager or accounting entity. Thus, a permanent record of receipts may be maintained in connection with each expense report, and the process of reviewing expense reports may be made more efficient and accurate.

Yet another advantage of the invention is that one or more delegates, or agents, may be authorized to act on behalf of an employee in preparing and/or submitting an expense report and associated receipts. In a particular embodiment, a delegate of an employee may prepare an expense report for the employee, but only the employee him or herself—and not the delegate for the employee—is authorized to submitted the completed expense report for review. In such embodiments, submitting the expense report may act as the employee's signature on the expense report. Thus, the occurrence of fraudulent or inaccurate expense reports may be reduced.

Other advantages will be readily apparent to one having ordinary skill in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates an example system for managing the reimbursement of expenses using expense reports according to an embodiment of the present invention; and

FIG. 2 illustrates an example method of managing the reimbursement of expenses using expense reports according to an embodiment of the present invention.

### DETAILED DESCRIPTION OF THE DRAWINGS

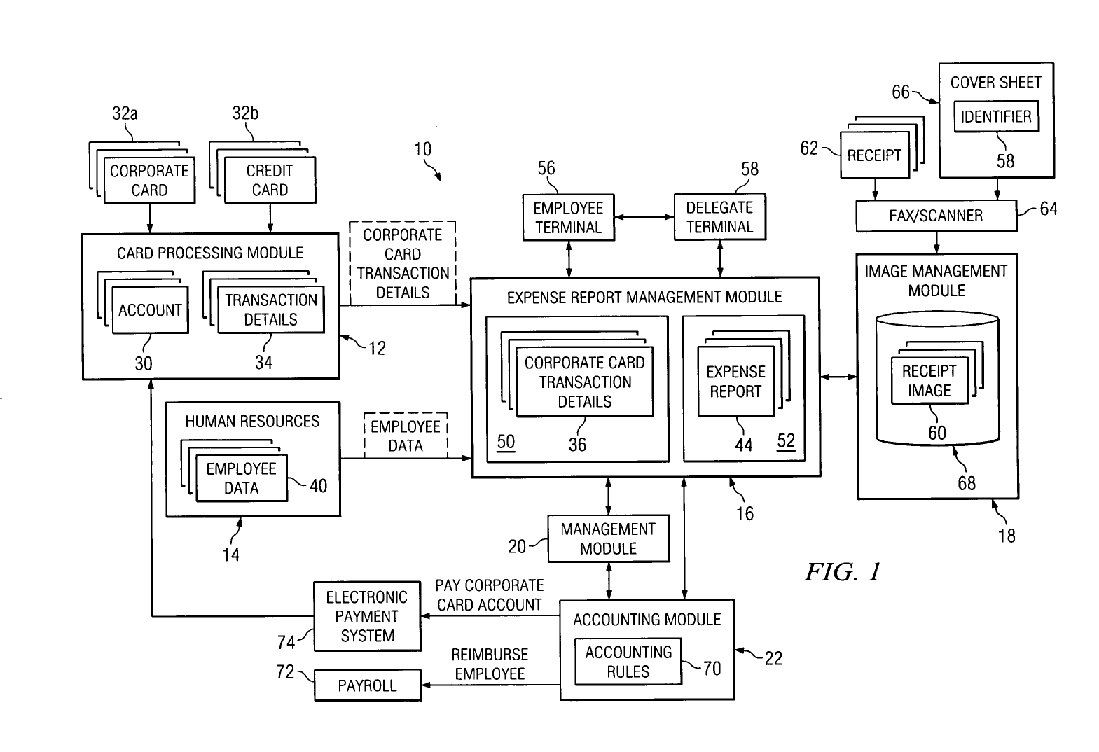

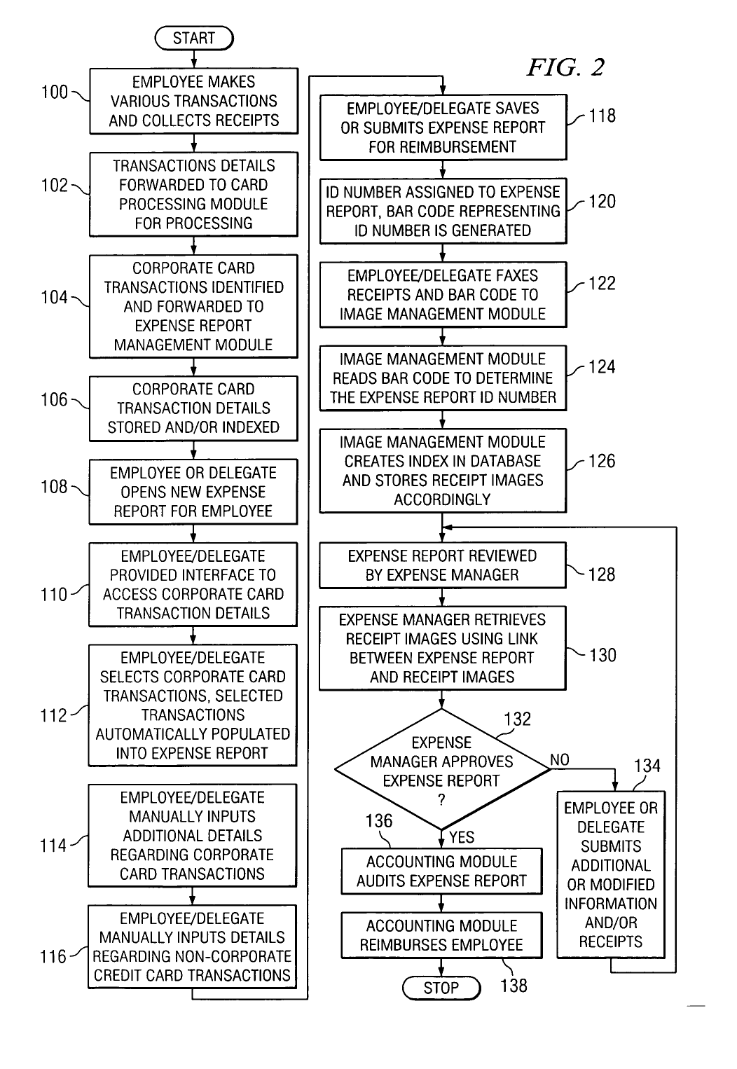

Example embodiments of the present invention and their advantages are best understood by referring now to FIGS. 1 through 2 of the drawings, in which like numerals refer to like parts. In general, a system is provided for managing expense reports and the reimbursement of expenses, such as business-related expenses incurred by an employee using a corporate credit card, for example. An employee uses a corporate credit card to make various business-related, reimbursable transactions. The details of the transactions are automatically downloaded into an application such that they may be accessed by the employee or a delegate acting on behalf of the employee. The employee or delegate may select individual transactions to be automatically populated into an expense report and, if appropriate, add additional details regarding the selected transactions or other transactions made not using the corporate credit card (e.g., “out of pocket” expenses). After completing the expense report, the employee or delegate may then submit the expense report for review. In particular embodiments, only the employee (and not a delegate) may actually submit the employee's expense report for review.

The employee or delegate may then print off a cover sheet having a computer-readable identifier printed thereon, which identifier represents an ID number corresponding to the expense report. The employee or delegate may then fax or otherwise electronically transmit the cover sheet and receipts associated with one or more transactions included in the expense report to an image management system. The image management system may automatically identify the ID number corresponding to the expense report based on the computer-readable identifier located on the cover sheet. The image management system may then create an index for the identified ID number and file the received receipt images under the created index, such that a link is created between the received receipt images and the expense report. A manager and/or an accounting system reviewing the expense report may retrieve the receipt images from the image management system using the link between the received receipt images and the expense report. If the expense report is approved, the employee may be automatically reimbursed for any reimbursable expenses, which may include automatic electronic crediting of the account for the employee's corporate credit card and/or reimbursements via payroll or other means.

FIG. 1 illustrates an example system 10 for managing the reimbursement of expenses using expense reports according to an embodiment of the present invention. As shown, system 10 may include a plurality of modules, such as a credit card processing module 12, a human resources module 14, an expense report management module 16, an image management module 18, a management module 20, and an accounting module 22.

Credit card processing module 12 is generally operable to manage credit card accounts and/or credit card transactions associated with credit card accounts. In certain embodiments, credit card processing module 12 comprises a card processing system for a credit card issuer or credit account provider. In a particular embodiment, credit card processing module 12 comprises a UNISYS credit card processing system platform.

Credit card processing module 12 may be operable to manage credit accounts 30 associated with credit cards 32, such as managing lines of credit and account balances and such credit accounts 30, for example. Credit card processing module 12 may also be operable to receive and process transaction details 34 of credit card transactions made using various credit cards 32 from various merchants, points of sale, or any other entity that performs credit card transactions. In certain embodiments, credit card processing module 12 manages credit accounts 30 and transaction details 34 associated with multiple types of credit accounts 30 and/or credit cards 32, such as fixed rate credit cards, variable rate credit cards, store cards, charge cards, and corporate cards, for example. In the embodiment shown in FIG. 1, corporate credit cards are indicated as cards 32a, while non-corporate credit cards are indicated as cards 32b. As used herein, the term “credit card” may also include debit cards.

In some embodiments, credit card processing module 12 is operable to identify transaction details 34 for credit card transactions made by corporate card 32a, and copy and forward (or download) such transaction details 34 to the expense report management module 16 for storage. Such transaction details 34 are indicated in FIG. 1 as corporate card transaction details 36. In some embodiments, credit card processing module 12 may run a periodic routine (such as once daily, for example) to identify corporate card transaction details 36 for credit card transactions made by corporate cards 32a, and copy and forward such corporate card transaction details 36 to expense report management module 16.

Human resources module 14 is generally operable to store and manage employee data 40 regarding any number of employees of one or more organizations, one or more of which may be cardholders of credit cards 32 managed by credit card processing module 12. For example, in an embodiment in which system 10 is associated with a credit card provider organization, human resources module 14 may store and manage employee data 40 regarding employees of the credit card provider organization, some or all of which may be cardholders of corporate credit cards 32a provided by or otherwise associated with the credit card provider organization, for example. Employee data 40 may include any relevant data regarding each employee, such as data regarding whether that employee is a cardholder, the position of that employee in the organization, and whether that employee is approved for reimbursement of various expenses (e.g. travel expenses or purchases on behalf of the organization).

Expense report management module 16 is generally operable to facilitate and otherwise manage the preparation of employee expense reports 44. In some embodiments, expense report management module 16 comprises an application server or platform, such as a PEOPLESOFT, SAP, or ORACLE server or platform, for example.

Expense report management module 16 may include a corporate card transaction application 50 operable to store corporate card transaction details 36 received from credit card processing module 12, and an expense report application 52 operable to facilitate the generation of expense reports 44 for employees. As shown in FIG. 1, expense report management module 16—including corporate card transaction application 50 and expense report application 52—may be accessed by an employee via an employee terminal 56 and/or any suitable number of delegates acting on behalf of the employee via delegate terminals 58. Employee terminals 56 and delegate terminals 58 may comprise any one or more computers, such as a desktop (personal) computer, workstation, network computer, wireless data port, wireless telephone, personal digital assistant, one or more processors within these or other devices, or any other suitable processing device. An employee may have zero, one or more delegates authorized by system 10 to act on behalf of the employee with respect to particular functions regarding generating an expense report 44, as discussed below in greater detail.

Corporate card transaction details 36 for particular transactions stored by corporate card transaction application 50 may identify the particular corporate card account 30 from which the transaction was made. Thus, in some embodiments, corporate card transaction application 50 may index corporate card transaction details 36 according to the corporate card account 30 with which they are associated. Thus, corporate card transaction details 36 for transactions made using a particular corporate card 32a may be easily accessed.

As mentioned above, expense report application 52 facilitates the generation of expense reports 44 for employees. For example, expense report application 52 may provide an employee, or a delegate acting on behalf of an employee, an interface for populating and editing an expense report 44, such as an expense report 44 related to a business trip, for instance. In some embodiments, expense report application 52 is linked to corporate card transaction application 50 and provides the employee or delegate an interface for accessing corporate card transaction application 50 such that the employee or delegate may (1) access and view corporate card transaction details 36 of transactions made using the employee's corporate card, and (2) select one or more of such transactions to populate into an expense report 44 maintained by expense report application 52. Thus, an employee (or a delegate acting on behalf of the employee) may simply select particular corporate card transactions related to a particular expense report 44 (e.g., transactions related to a particular business trip), and the corporate card transaction details 36 of such selected transactions may be automatically populated into the particular expense report 44.

Expense report application 52 may also provide the employee or the employee's delegate an interface to modify particular details and/or add additional details regarding particular corporate card transactions. For example, for a credit card transaction of a hotel bill, the employee or the employee's delegate may be instructed or required to enter data specifying the amount of the total bill that should be allocated to the room charge, the amount of the total bill that should be allocated to meals, and the amount of the total bill that should be allocated to tax. Such additional information may be desired or required for IRS purposes, internal auditing purposes, or any other purpose. In addition, expense report application 52 may also provide the employee or the employee's delegate an interface to add details regarding additional transactions to the expense report 44 that were not made using the corporate credit card 32a. For example, the employee or the employee's delegate may add to the expense report 44 transactions made using cash, check, debit card, or another credit card, as well as items for which a receipt may not be applicable, such as automobile mileage reimbursement, for example.

Expense report application 52 may also provide the employee and/or the employee's delegate an interface to submit the expense report 44 for review by management module 20 and/or accounting module 22, as discussed below. In particular embodiments, only the employee has access, or is authorized, to submit an expense report 44 for review; delegates of the employee may be restricted from such access or authority. In other embodiments, an employee's delegate(s) may be authorized to act on behalf of the employee with respect to any particular functions regarding generating an expense report 44, and restricted from acting on behalf of the employee with respect to other particular functions regarding generating the expense report 44. Expense report application 52 may store and/or manage delegate or agent relationships between particular employees and one or more delegates (which may be other employees) authorized to act on behalf of such employees in preparing, saving and/or submitting expense reports for such employees.

Expense report application 52 may generate and/or assign an ID number for a particular expense report 44 and generate a computer-readable identifier 58 that corresponds with the ID number and from which the ID number may be determined. In some embodiments, expense report application 52 may generate and/or assign an ID number for a particular expense report 44 in response to particular actions taken by the employee and/or delegate, including saving the expense report 44 or submitting the expense report 44 for review. In embodiments in which only the employee (and not a delegate) is authorized to submit his or her expense report 44 for review, a delegate who is preparing the expense report 44 on behalf of the employee may save the expense report 44, which triggers expense report application 52 to assign an ID number for the expense report 44 and generate a corresponding computer-readable identifier 58. The delegate may then access and use the computer-readable identifier 58 to fax or otherwise submit receipts 62 associated with the expense report 44.

The ID number for an expense report 44 may include any one or more characters, such as a string of numbers, letters and/or other symbols, or may comprise any other type of identifier that may be used to identify a particular expense report 44. A computer-readable identifier 58 may comprise any computer-readable representation of an ID number. For example, computer-readable identifiers 58 may include computer-readable bar codes, symbols that are computer-readable via optical character recognition (OCR), or numbers or other characters transmitted by fax, telephone, the Internet, or otherwise transmitted via wireline or wireless electronic communications.

As discussed below with reference to image management module 18, a computer-readable identifier 58 generated for a particular expense report 44 may be transmitted along with one or more receipt images 60—i.e., images of one or more receipts 62—associated with that particular expense report to image management module 18, which may read such computer-readable identifier 58 to determine the particular expense report 44 and index the one or more receipt images 60 accordingly such that the one or more receipt images 60 are linked to the expense report 44 maintained by expense report application 52, and such that the one or more receipt images 60 may be easily retrieved, such as by a manager reviewing the particular expense report 44.

As shown in FIG. 1, expense report application 52 may be linked to image management module 18 such that particular receipt images 60 may be linked to expense reports 44 with which such receipt images 60 are associated, as discussed below in greater detail.

Image management module 18 is generally operable to receive and manage images of receipts 62, which may be referred to as receipt images 60. Image management module 18 includes device(s) operable to receive electronic images or representations of receipts 62 and, in some embodiments, electronic images or representations of identifiers 58 corresponding to particular receipts 62. In some embodiments, image management module 18 includes a fax server operable to receive faxed or scanned images of receipts 62 and identifiers 58 via a fax machine or scanner 64 coupled to image management module 18 via a communications network. For example, an identifier 58 for a particular expense report 44 may be a bar code or other computer-readable symbols printed on a cover sheet 66 that may be faxed along with one or more receipts 62 associated with that particular expense report 44. As used herein, the function of “receiving images” of receipts 62 (e.g. receiving receipt images 60) or identifiers 58 refers to receiving any electronic representation of receipts 62 or identifiers 58, such as receiving data via fax, the Internet, or otherwise via a communications network.

As shown in FIG. 1, image management module 18 may include an image database 68 operable to store received receipt images 60. When image management module 18 has determined that receipt images 60 and an identifier 58 have been received, image management module 18 may read the computer-readable identifier 58 to determine the ID number for the particular expense report 44 associated with the receipt images 60 and identifier 58. In particular embodiments in which image management module 18 comprises a fax server, the fax server may periodically check for such newly received faxes, such as every seven minutes, for example.

After receiving receipt images 60 and an identifier 58, and determining the ID number represented by the identifier 58, image management module 18 may index the receipt images 60 using the determined ID number corresponding with the particular expense report 44. For example, image management module 18 may create an index with the determined ID number and file the associated receipt images 60 under that index such that the receipt images 60 may be retrieved via the index, such as by a manager who wishes to view the receipt images 60 in connection with the manager's review of the particular expense report 44.

Management module 20 may cooperate with expense report management module 16 to provide an interface for one or more expense managers (for example, the employee's manager or supervisor) to access and review expense reports 44 submitted by employees (and if permitted, by delegates on behalf of employees). Management module 20 may also cooperate with image management module 18 (either directly or via expense report management module 16) to provide an interface for accessing and viewing receipt images 60 submitted by employees and/or delegates of employees. The expense manager may review an expense report 44 and/or the receipt images 60 associated with that expense report 44 and make various determinations regarding the expense report 44, such as whether to approve the expense report 44, reject the expense report 44, request additional information from the employee regarding particular expense items, request a receipt 62 for one or more particular expenses listed on the expense report 44, or request the employee to correct or modify particular data, for example.

In certain embodiments, an expense manager may submit a request via management module 20 to retrieve one or more receipt images 60 associated with a particular expense report 44 from image management module 18. The request may be communicated to expense report management module 16, which may utilize the link previously between the particular expense report 44 and the receipt images 60 previously generated by image management module 18 and/or expense report management module 16 to retrieve the requested receipt images 60 associated with the particular expense report 44. For example, an expense manager accessing an expense report 44 via an interface provided by expense report management module 16 may wish to view one or more of the receipts 62 associated with that expense report 44. Expense report application 52 may provide the expense manager an interface to request the retrieval of receipt images 60 for individual (or all) receipts 62 associated with the expense report 44. For example, such interface may comprise one or more links which the expense manager may click (such as using a mouse or other pointer) to submit a request to view receipt images 60 associated with the expense report 44. Once the requested receipt images 60 are retrieved from image management module 18, management module 20 may display the one or more retrieved receipt images 60 to the expense manager.

Accounting module 22 is generally operable to communicate with expense report management module 16 to audit employees' expense reports 44, which may include pre-payment and/or post-payment audits. Accounting module 22 may apply a set of accounting rules 70 to the expenses listed in an expense report 44 to identify any relevant accounting issues with the expense report 44, such as whether the threshold amount for a particular type of expense has been exceeded, whether required receipts 62 have been submitted, and whether “miscellaneous” expenses are valid for reimbursement, for example. Accounting rules 70 may include, for example, rules regarding the policy of the organization, standards for expense report submittal, and IRS regulations regarding reimbursement of expenses. In some embodiments, accounting module 22 may also apply post-payment audits of expense reports 44, such as for IRS purposes.

Accounting module 22 may determine, based on an audit of an expense report 44, an amount to reimburse the employee's corporate card 32a and/or an amount to otherwise reimburse the employee, such as via payroll or check, as indicated by reference numeral 72. For amounts to be reimbursed to an employee's corporate card, accounting module 22 may communicate the relevant amount and account number to an electronic payment system 74 that may communicate with card processing module 12 to directly credit the account 30 associated with the employee's corporate credit card 32a.

Each module 12-22 in system 10 may include software and/or hardware operable to provide the functionality associated with that module 12-22. For example, each module 12-22 may include one or more computer systems that include appropriate input devices, output devices, mass storage media, processors, memory, or other components for receiving, processing, storing, and/or communicating information with other components of system 10. As used in this document, the term “computer” refers to any suitable device operable to accept input, process the input according to predefined rules, and produce output, for example, a desktop (personal) computer, workstation, network computer, wireless data port, wireless telephone, personal digital assistant, one or more processors within these or other devices, or any other suitable processing device. Each module 12-22 may include software or other executable instructions that may be executed by one or more processing units to perform various functions associated with that module 12-22. Such processing units may comprise any suitable processor(s) that execute various software or other computer instructions associated with modules 12-22, such as central processing units (CPUs) or other microprocessors, and may include any suitable number of processors working together.

Each module 12-22 may also include one or more memory units and/or network interfaces. Such memory units may include one or more suitable memory devices, such as one or more random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), microcontrollers, or microprocessors. The one or more network interfaces may provide an interface between modules 12-22 and/or between a particular modules 12-22 and one or more external entities, such as credit bureaus, banks, customers of collections accounts, etc.

The functionality of one or more of modules 12-22 may be provided at least partially by humans. For example, as discussed below in greater detail, one or more humans, such as expense managers and/or accountants may provide various functionality associated with management module 20 and/or accounting module 22.

Modules 12-22, as well as the components of each particular module 12-22, may be located at a single site or, alternatively, at a number of different sites. In addition, modules 12-22, as well as the components of each particular module 12-22, may be coupled to each other using one or more links, each of which may include one or more computer buses, local area networks (LANs), metropolitan area networks (MANs), wide area networks (WANs), portions of the Internet, or any other appropriate wireline, optical, wireless, or other links.

FIG. 2 illustrates a method of managing the reimbursement of expenses for a particular employee using an expense report 44 according to an embodiment of the present invention. At step 100, an employee incurs various expenses during a business trip, including one or more transactions using a corporate credit card 32a, one or more transactions using another credit card 32b, one or more cash transactions and/or other transactions or expenses. The employee may collect receipts for some or all of the various transactions.

At step 102, transactions details 34 regarding the transactions made by the employee using corporate credit card 32a and/or the non-corporate credit card 32b are forwarded to card processing module 12 for processing. Steps 102 and 100 may be substantially simultaneous or overlapping. For example, transactions details 34 regarding each transactions made using corporate credit card 32a and/or the non-corporate credit card 32b may be forwarded to card processing module 12 substantially in real time, or at some periodic interval.

At step 104, card processing module 12 automatically identifies, from the transactions details 34 of the transactions made by the employee using corporate credit card 32a and/or the non-corporate credit card 32b, the transactions made using the corporate card 32a. Card processing module 12 may then communicate the transactions details 34 of such identified transactions made using the corporate credit card 32a, indicated as corporate card transaction details 36, to expense report management module 50.

At step 106, the corporate card transaction details 36 may be stored and/or indexed by corporate card transaction application 50. In some embodiments, corporate card transaction application 50 may identify, based on corporate card transaction details 36, the particular corporate card 32a with which the transactions were made and sort or index the corporate card transaction details 36 accordingly. For example, the corporate card transaction details 36 identified as being associated with the employee's corporate card 32a may be stored such that the employee and/or one or more authorized delegates for the employee may access the corporate card transaction details 36, such as by entering a user ID, a password, or other authorization data.

At step 108, the employee using an employee terminal 56, or a delegate acting on behalf of the employee using a delegate terminal 58, may access expense report application 52 to open a new expense report 44 for the employee's business trip. The employee or delegate may enter a user ID, a password, or other authorization data such that expense report application 52 may identify the employee and open a new expense report 44 for the employee. Expense report application 52 may cause the new expense report 44 to be displayed to the employee or delegate via the employee terminal 56 or delegate terminal 58.

At step 110, expense report application 52 may provide the employee or delegate an interface to access, via corporate card transaction application 50, corporate card transaction details 36 associated with transactions made by the employee using the employee's corporate card 32a. For example, expense report application 52 may display a link associated with the displayed expense report 44 to access corporate card transaction details 36 from corporate card transaction application 50.

At step 112, the employee or delegate may link to corporate card transaction application 50 to access corporate card transaction details 36 associated with transactions made by the employee using the employee's corporate card 32a. For example, the employee or delegate may click on a button providing access to and/or a view of the corporate card transaction details 36. The corporate card transaction details 36 associated with the employee may include one or more reimbursable transactions made during the business trip, one or more non-reimbursable transactions made during the business trip, and/or one or more transactions unrelated to the business trip (such as transactions made during a different business trip, for example). Expense report application 52 may display the various corporate card transaction details 36 to the employee or delegate and provide the employee or delegate an interface for selecting from the various corporate card transactions particular transactions that the employee or delegate wishes to include in the expense report 44, such as by clicking a button associated with the corporate card transaction details 36 for each transaction. The corporate card transaction details 36 selected by the employee or delegate may be automatically populated into the expense report 44.

At step 114, expense report application 52 may also provide an interface allowing the employee or delegate to manually input additional details regarding one or more credit card transaction that has been selected and populated into the expense report 44. For example, the employee or delegate may click on an expense item in the expense report 44 detailing a hotel transaction, expense report application 52 may provide an interface for entering additional details regarding the hotel transaction, and the employee or delegate may enter the additional details, such as details specifying the amount of the total bill that should be allocated to the room charge, the amount of the total bill that should be allocated to meals, and the amount of the total bill that should be allocated to tax. As discussed above, such additional information may be desired or required for IRS purposes, internal auditing purposes, or any other purpose.

At step 116, expense report application 52 may also provide an interface allowing the employee or delegate to manually add additional transactions to the expense report that were not made using the employee's corporate card 32a. For example, the employee or delegate may add to the expense report 44 details regarding transactions made using cash, check, debit card, or another credit card, as well as items for which a receipt may not be applicable, such as automobile mileage reimbursement, for example.

At step 118, once the expense report 44 has been completed by the employee and/or delegate, the expense report 44 may be submitted for review. In certain embodiments, only the employee (and not a delegate of the employee) is authorized to submitted an expense report 44. In such embodiments, the actions taken by the employee (e.g., clicking a “submit expense report” button) to submit the expense report 44 acts as the employee's signature on the expense report 44. In other embodiments, the employee or a delegate of the employee may submit the expense report 44 may be submitted for reimbursement.

At step 120, expense report application 52 may assign an ID number to the expense report 44 and index the expense report 44 accordingly. Expense report application 52 may generate and provide the employee or delegate access to a computer-readable identifier 58 that represents the ID number of the expense report 44, such as a computer-readable bar code, for example. The employee or delegate may then print out the computer-readable identifier 58, such as on a cover sheet, for example, which may then be electronically transmitted to image management module 18 along with one or more receipts 62, as discussed below. Expense report application 52 may assign the ID number to the expense report 44 and generate the corresponding computer-readable identifier 58 in response to the expense report 44 being submitted for review. In some embodiments, expense report application 52 may also assign the ID number to the expense report 44 and generate the corresponding computer-readable identifier 58 in response to the expense report 44 being saved. In such embodiments, a delegate working on an employee's expense report 44 that is not be authorized to submit the expense report 44 on behalf of the employee may be able to cause the generation of, and gain access to, a computer-readable identifier 58 for the expense report 44 by saving the expense report 44.

At step 122, the employee or delegate may transmit any receipts 62 for transactions included in the expense report 44, along with the computer-readable identifier 58 generated for the expense report at step 120, to image management module 18 using a transmission device 64 such as a fax machine or scanner coupled to image management module 18 by a communications network. In a particular embodiment, the employee or delegate may print out a cover sheet 66 having a bar code identifier 58 that represents the ID number of the employee's expense report 44. The employee or delegate may then fax cover sheet 66, along with any receipts 62 for transactions included in the expense report 44, to image management module 18.

At step 124, image management module 18 may determine that new receipt images have been received and automatically read the computer-readable identifier 58 included with the received images to determine the ID number of the associated expense report 44. For example, in an embodiment in which the computer-readable identifier 58 comprises a bar code, image management module 18 may automatically read the bar code to determine the encoded ID number of the associated expense report 44. As another example, in an embodiment in which the computer-readable identifier 58 comprises one or more computer-readable characters or symbols, image management module 18 may use optical character recognition (OCR) to automatically determine the encoded ID number of the associated expense report 44.

At step 126, image management module 18 may then create an index in image database 68 for the received receipt images 60 with the ID number determined from the identifier 58. The received receipt images 60 may be stored in image database 68 under the created index. The index may act as a link between the receipt images 60 stored in image database 68 and the expense report 44 maintained by expense report application 52 such that the receipt images 60 may be easily accessed and/or retrieved in connection with the expense report 44, such as for review by an expense manager or an accounting system, for example.

At step 128, an expense manager using management module 20 may review the expense report 44 maintained by expense report application 52. Management module 20 may communicate with expense report application 52 to generate a display of the expense report 44, the display identifying each of the transactions included in the expense report 44, including one or more transactions made using the corporate credit card 32a and/or one or more other transactions. The display may include an interface for accessing the receipt images 60 of the receipts 62 indexed in image database 68 under the ID number associated with the expense report 44. For example, the display of the expense report 44 may include a hotlink button which may be clicked in order to retrieve the receipt images 60 associated with the expense report 44.

At step 130, the expense manager may use the interface to submit a request to retrieve and view one or more of the receipt images 60, such as by clicking a hotlink button as discussed above. The request may be received by expense report management module 16, which may use the link between the expense report 44 and the receipt images 60 associated with the expense report 44 to retrieve the receipt images 60 from image database 68. The retrieved images may then be displayed to the expense manager via a display associated with management module 20. Alternatively, management module 20 and image management module 18 may communicate directly in order to retrieve the requested receipt images 60 from image database 68.

At step 132, the expense manager may make various determinations regarding the expense report 44, such as whether to approve the expense report 44, reject the expense report 44, request additional information from the employee regarding particular expense items, request additional receipts 62 for one or more particular expenses listed on the expense report 44, or request the employee to correct or modify particular data, for example. Such determinations may be communicated to the employee and/or any delegates authorized to act on behalf of the employee.

If the expense manager has rejected the expense report 44, request additional information from the employee, or requested the employee to modify particular data, the employee or delegate may submit such additional or modified information and/or receipts 62 at step 134.

After the expense manager approves the expense report 44, accounting module 22 may apply a pre-payment audit of the expense report 44 at step 136. In particular, accounting module 22 may apply a set of accounting rules 70 to the expenses listed in the expense report 44 to identify any relevant accounting issues with the expense report 44, as discussed above. In some embodiments, accounting module 22 may also apply post-payment audits of expense reports 44, such as for IRS purposes.

At step 138, accounting module 22 may determine, based on the audit at step 136, one or more amounts to reimburse the employee. Such reimbursement may include reimbursement of the employee's corporate card account 30 and/or additional reimbursement of the employee, such as via payroll, as indicated by reference numeral 72, or a check or otherwise. For the amount to be reimbursed to the employee's corporate card account 30, accounting module 22 may communicate the relevant amount and account number to an electronic payment system 74 that may communicate with card processing module 12 to directly credit the account 30 associated with the employees corporate credit card 32a.

Although an embodiment of the invention and its advantages are described in detail, a person skilled in the art could make various alterations, additions, and omissions without departing from the spirit and scope of the present invention as defined by the appended claims.

1. A method of managing expenses, comprising:
electronically receiving an expense report including details of one or more expenses incurred by an employee;
receiving electronic images of one or more receipts associated with at least one of the one or more expenses;
electronically receiving a computer-readable identifier associated with the one or more receipts, the computer-readable identifier corresponding with the expense report;
automatically identifying the expense report based on the received computer-readable identifier; and
in response to identifying the expense report based on the received computer-readable identifier, automatically generating a link between the identified expense report and the electronic images of the one or more receipts, wherein the link may be used to retrieve the electronic images of the one or more receipts.

2. The method of claim 1, wherein:
the expense report includes details of one or more credit card transactions made by the employee using a credit card; and
receiving electronic images of one or more receipts associated with at least one of the one or more expenses comprises receiving electronic images of one or more receipts associated with at least one of the one or more credit card transactions.

3. The method of claim 2, wherein the expense report further includes details of one or more credit card transactions not made using the credit card;

4. The method of claim 1, wherein:
the computer-readable identifier comprises a bar code; and
automatically identifying the expense report based on the received computer-readable identifier comprises automatically reading the bar code.

5. The method of claim 1, wherein:
the computer-readable identifier comprises one or more characters; and
automatically identifying the expense report based on the received computer-readable identifier comprises automatically reading the one or more characters using optical character recognition.

6. The method of claim 1, wherein receiving a computer-readable identifier associated with the one or more receipts comprises receiving an electronic image of a cover sheet including the computer-readable identifier.

7. The method of claim 6, wherein receiving an electronic image of a cover sheet including the computer-readable identifier comprises receiving a faxed or scanned image of a cover sheet including the computer-readable identifier.

8. The method of claim 1, wherein:
the expense report has an associated identification number; and
the computer-readable identifier comprises a representation of the identification number associated with the expense report.

9. The method of claim 8, wherein:
automatically identifying the expense report based on the received computer-readable identifier comprises automatically identifying the identification number associated with the expense report based on the received computer-readable identifier; and
generating a link between the identified expense report and the electronic images of the one or more receipts comprises creating an index having the automatically identified identification number associated with the expense report.

10. The method of claim 1, wherein the electronic images of the one or more receipts comprise faxed images of the receipts.

11. The method of claim 1, wherein the electronic images of the one or more receipts comprise scanned images of the receipts.

12. The method of claim 1, further comprising:
receiving a request to retrieve at least one of the electronic images of the one or more receipts; and
in response to receiving the request, using the link to retrieve the at least one electronic image.

13. The method of claim 12, further comprising:
generating a display of the expense report, the display identifying each of the one or more expenses and providing an expense manager an interface for accessing the electronic images of one or more receipts; and
wherein receiving a request to retrieve at least one of the electronic images of the one or more receipts and using the link to retrieve the at least one electronic image comprises:
receiving from the expense manager via the interface a request to display at least one of the electronic images of the one or more receipts;
using the link between the identified expense report and the electronic images of the one or more receipts to retrieve the requested at least one electronic image; and
displaying the retrieved at least one electronic image to the expense manager.

14. The method of claim 13, further comprising:
the expense report including details of one or more credit card transactions made using a credit card associated with the employee;
receiving one or more approval determinations regarding whether to approve for reimbursement a particular one of the one or more credit card transactions included in the expense report;
if the particular credit card transaction is approved for reimbursement based on the one or more approval determinations, automatically crediting an account associated with the credit card for the approved particular credit card transaction.

15. The method of claim 1, further comprising:
receiving from a credit card processing system details of a plurality of credit card transactions made using a credit card associated with the employee;
providing a user interface allowing a user to select from the plurality of credit card transactions particular credit card transactions to be populated into the expense report;
receiving from the user a selection of one or more credit card transactions to be populated into the expense report; and
automatically populating the expense report with the details of the one or more selected credit card transactions.

16. The method of claim 15, wherein:
the credit card is a particular corporate card; and
the method further comprises:
the credit card processing system receiving details of a plurality of credit card transactions made using a plurality of credit cards including the particular corporate card;
the credit card processing system automatically identifying, from the plurality of credit card transactions made using a plurality of credit cards, credit card transactions made using the particular corporate card; and
the credit card processing system communicating the details of the identified plurality of credit card transactions made using the particular corporate credit card.

17. The method of claim 15, further comprising:
providing the user an interface allowing the user to manually input additional details regarding a particular credit card transaction selected and automatically populated into the expense report;
providing the user an interface allowing the user to manually input additional transactions into the expense report, the additional transactions including transactions not made using the credit card.

18. The method of claim 15, wherein the user may be the employee or a delegate acting on behalf of the employee.

19. The method of claim 18, further comprising:
providing the employee or a delegate acting on behalf of the employee access to view the details of the plurality of credit card transactions and to select the particular credit card transactions to be populated into the expense report;
providing only the employee access to submit the expense report for reimbursement.

20. The method of claim 1, further comprising:
providing the employee or a delegate acting on behalf of the employee access to complete the expense report;
providing only the employee access to submit the expense report for review.

21. A system for managing expenses, comprising:
an expense report management module operable to electronically receiving an expense report including details of one or more expenses incurred by an employee; and
an image management module operable to:
receive electronic images of one or more receipts associated with at least one of the one or more expenses;
electronically receive a computer-readable identifier associated with the one or more receipts, the computer-readable identifier corresponding with the expense report;
automatically identify the expense report based on the received computer-readable identifier; and
in response to identifying the expense report based on the received computer-readable identifier, automatically generate a link between the identified expense report and the electronic images of the one or more receipts, wherein the link may be used to retrieve the electronic images of the one or more receipts.

22. The system of claim 21, wherein:
the expense report includes details of one or more credit card transactions made by the employee using a credit card; and
receiving electronic images of one or more receipts associated with at least one of the one or more expenses comprises receiving electronic images of one or more receipts associated with at least one of the one or more credit card transactions.

23. The system of claim 21, wherein the expense report further includes details of one or more credit card transactions not made using the credit card;

24. The system of claim 21, wherein:
the computer-readable identifier comprises a bar code; and
automatically identifying the expense report based on the received computer-readable identifier comprises automatically reading the bar code.

25. The system of claim 21, wherein:
the computer-readable identifier comprises one or more characters; and
automatically identifying the expense report based on the received computer-readable identifier comprises automatically reading the one or more characters using optical character recognition.

26. The system of claim 21, wherein receiving an electronic image of a cover sheet including the computer-readable identifier comprises receiving a faxed or scanned image of a cover sheet including the computer-readable identifier.

27. The system of claim 21, wherein:
the expense report has an associated identification number; and
the computer-readable identifier comprises a representation of the identification number associated with the expense report.

28. The system of claim 27, wherein:
automatically identifying the expense report based on the received computer-readable identifier comprises automatically identifying the identification number associated with the expense report based on the received computer-readable identifier; and
generating a link between the identified expense report and the electronic images of the one or more receipts comprises creating an index having the automatically identified identification number associated with the expense report.

29. The system of claim 21, wherein the expense report management module is further operable to:
receive a request to retrieve at least one of the electronic images of the one or more receipts; and
in response to receiving the request, use the link to retrieve the at least one electronic image.

30. The system of claim 29, further comprising:
a management module operable to generate a display of the expense report, the display identifying each of the one or more expenses and providing an expense manager an interface for accessing the electronic images of one or more receipts; and
wherein the expense report management module receiving a request to retrieve at least one of the electronic images of the one or more receipts and using the link to retrieve the at least one electronic image comprises:
receiving from the expense manager via the interface a request to display at least one of the electronic images of the one or more receipts;
using the link between the identified expense report and the electronic images of the one or more receipts to retrieve the requested at least one electronic image; and
displaying the retrieved at least one electronic image to the expense manager.

31. The system of claim 30, wherein:
the expense report includes details of one or more credit card transactions made using a credit card associated with the employee; and
the system further comprises an accounting module operable to:
receive one or more approval determinations regarding whether to approve for reimbursement a particular one of the one or more credit card transactions associated with the expense report; and
if the particular credit card transaction is approved for reimbursement based on the one or more approval determinations, automatically credit the credit card for the approved particular credit card transaction.

32. The system of claim 21, further comprising:
a credit card processing module operable to communicate to the expense report management module details of a plurality of credit card transactions made using a credit card associated with the employee;
the expense report management module providing a user interface allowing a user to select from the plurality of credit card transactions particular credit card transactions to be populated into the expense report;
the expense report management module operable to:
receive from the user a selection of one or more credit card transactions to be populated into the expense report; and
automatically populate the expense report with the details of the one or more selected credit card transactions.

33. The system of claim 32, wherein:
the credit card is a particular corporate card; and
the credit card processing module is operable to:
receive details of a plurality of credit card transactions made using a plurality of credit cards including the particular corporate card;
automatically identify, from the plurality of credit card transactions made using a plurality of credit cards, credit card transactions made using the particular corporate card; and
communicate the details of the identified plurality of credit card transactions made using the particular corporate credit card to the expense report management module.

34. The system of claim 32, further comprising:
the expense report management module providing a user interface allowing the user to:
manually input additional details regarding a particular credit card transaction selected and automatically populated into the expense report; and
manually input additional transactions into the expense report, the additional transactions including transactions not made using the credit card.

35. The system of claim 32, wherein the user may be the employee or a delegate acting on behalf of the employee.

36. The system of claim 35, further comprising:
the expense report management module providing the employee or a delegate acting on behalf of the employee access to view the details of the plurality of credit card transactions and to select the particular credit card transactions to be populated into the expense report;
the expense report management module providing only the employee access to submit the expense report for reimbursement.

37. The system of claim 21, further comprising:
the expense report management module providing the employee or a delegate acting on behalf of the employee access to complete the expense report;
the expense report management module providing only the employee access to submit the expense report for review.

38. A system for managing expenses, comprising:
a computer system having a processor; and
a computer-readable medium coupled to the computer system, the computer-readable medium comprising a program operable, when executed by the processor, to:
electronically receive an expense report including details of one or more expenses incurred by an employee;
receive electronic images of one or more receipts associated with at least one of the one or more expenses;
electronically receive a computer-readable identifier associated with the one or more receipts, the computer-readable identifier corresponding with the expense report;
automatically identify the expense report based on the received computer-readable identifier; and
in response to identifying the expense report based on the received computer-readable identifier, automatically generate a link between the identified expense report and the electronic images of the one or more receipts, wherein the link may be used to retrieve the electronic images of the one or more receipts.
